(19) United States
(12) Patent Application Publication
(10) Pub. No.: US 2016/0349993 A1
(43) Pub. Date: Dec. 1, 2016

(54) DATA-DRIVEN CEPH PERFORMANCE OPTIMIZATIONS

(71) Applicant: CISCO TECHNOLOGY, INC., San Jose, CA (US)

(72) Inventors: Yathiraj B. Udupi, San Jose, CA (US); Johnu George, San Jose, CA (US); Debojyoti Dutta, Santa Clara, CA (US); Kai Zhang, San Jose, CA (US)

(73) Assignee: CISCO TECHNOLOGY, INC., San Jose, CA (US)

(21) Appl. No.: 14/726,182

(22) Filed: May 29, 2015

(51) Int. Cl. G06F 3/06

(52) U.S. Cl. CPC G06F 3/061; G06F 3/0689; G06F 3/0619; G06F 3/0665; G06F 3/065

(57) ABSTRACT

The present disclosure describes, among other things, a method for managing and optimizing distributed object storage on a plurality of storage devices of a storage cluster. The method comprises computing, by a states engine, respective scores associated with the storage devices based on a set of characteristics associated with each storage device and a set of weights corresponding to the set of characteristics, and computing, by the states engine, respective bucket weights for leaf nodes and parent node(s) of a hierarchical map of the storage cluster based on the respective scores associated with the storage devices, wherein each leaf nodes represent a corresponding storage device and each parent node aggregates one or more storage devices.

### TECHNICAL FIELD

This disclosure relates in general to the field of computing and, more particularly, to data-driven Ceph performance optimizations.

### BACKGROUND

Cloud platforms offer a range of services and functions, including distributed storage. In the domain of distributed storage, storage clusters can be provisioned in a cloud of networked storage devices (commodity hardware) and managed by a distributed storage platform. Through the distributed storage platform, a client can store data in a distributed fashion in the cloud while not having to worry about issues related to replication, distribution of data, scalability, etc. Such storage platforms have grown significantly over the past few years, and these platforms allow thousands of clients to store petabytes to exabytes of data. While these storage platforms already offer remarkable functionality, there is room for improvement when it comes to providing better performance and utilization of the storage cluster.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 shows an exemplary hierarchical map of a storage cluster, according to some embodiments of the disclosure;

FIG. 2 shows an exemplary write operation, according to some embodiments of the disclosure;

FIG. 3 shows an exemplary read operation, according to some embodiments of the disclosure;

FIG. 4 is a flow diagram illustrating a method for managing and optimizing distributed object storage on a plurality of storage devices of a storage cluster, according to some embodiments of the disclosure;

FIG. 5 is a system diagram illustrating an exemplary distributed storage platform and a storage cluster, according to some embodiments of the disclosure;

FIG. 6 is an exemplary graphical representation of leaf nodes and parent nodes of a hierarchical map as a tree for display to a user, according to some embodiments of the disclosure;

FIG. 7 is an exemplary user interface element graphically illustrating one or more characteristics associated with a storage device being represented by a leaf, according to some embodiments of the disclosure;

FIG. 8 is another exemplary user interface element graphically illustrating one or more characteristics associated with a storage device being represented by a leaf, according to some embodiments of the disclosure;

FIG. 9 is an exemplary graphical representation of object distribution on placement groups, according to some embodiments of the disclosure; and

FIG. 10 is an exemplary graphical representation of object distribution on OSDs, according to some embodiments of the disclosure.

### DETAILED DESCRIPTION OF EXAMPLE EMBODIMENTS

### Overview

The present disclosure describes, among other things, a method for managing and optimizing distributed object storage on a plurality of storage devices of a storage cluster. The method comprises computing, by a states engine, respective scores associated with the storage devices based on a set of characteristics associated with each storage device and a set of weights corresponding to the set of characteristics, and computing, by the states engine, respective bucket weights for leaf nodes and parent node(s) of a hierarchical map of the storage cluster based on the respective scores associated with the storage devices, wherein each leaf nodes represent a corresponding storage device and each parent node aggregates one or more storage devices.

In some embodiments, an optimization engine determines based on a pseudo-random data distribution procedure, a plurality of storage devices for distributing object replicas across the storage cluster using the respective bucket weights.

In some embodiments, an optimization engine selects a primary replica from a plurality of replicas of an object stored in the storage cluster based on the respective scores associated with storage units on which the plurality of replicas are stored.

In some embodiments, the set of characteristics comprises one or more: capacity, latency, average load, peak load, age, data transfer rate, performance rating, power consumption, object volume, number of read requests, number of write requests, and availability of data recovery feature(s).

In some embodiments, computing the respective score comprises computing a weighted sum of characteristics based on the set of characteristics and the set of weights corresponding to the set of characteristics.

In some embodiments, computing the respective score comprises computing a normalized score as the respective score based on

$$\frac{c + S - Min}{c + Max - Min} ,$$

wherein c is a constant, S is the respective score, Min is the minimum score of all respective scores, and Max is the maximum score of all respective scores.

In some embodiments, computing the respective bucket weight for a particular leaf node representing a corresponding storage device comprises assigning the respective score associated with the corresponding storage device as the respective bucket weight for the particular leaf node.

In some embodiments, computing the respective bucket weight for a particular parent node aggregating one or more storage devices comprises assigning a sum of respective bucket weight(s) for child node(s) of the parent node in the hierarchical map as the respective bucket weight of the particular parent node.

In some embodiments, the method further includes updating, by the states manager, the respective bucket weights by computing the respective scores again in response to one or more storage devices being added to the storage cluster and/or one or more storage devices being removed from the storage cluster.

In some embodiments, the method further includes generating, by a visualization generator, a graphical representation of leaf nodes and parent node(s) of the hierarchical map as a tree for display to a user, wherein a particular leaf node of the tree comprises a user interface element graphically illustrating one or more of the characteristics in the set of characteristics associated with the corresponding storage device of being represented by the particular leaf node.

### EXAMPLE EMBODIMENTS

Understanding Ceph and CRUSH

One storage platform for distributed cloud storage is Ceph. Ceph is an open source platform, and is freely available the Ceph community. Ceph, a distributed object store and file system, allows system engineers to deploy of Ceph storage clusters with high performance, reliability, and scalability. Ceph stores a client's data as objects within storage pools. Using a procedure called, CRUSH “Controlled Replication Under Scalable Hashing”, a Ceph cluster can scale, rebalance, and recover dynamically. Phrased simply, CRUSH determines how to store and retrieve data by computing data storage locations, i.e., OSDs (Object-based Storage Devices or Object Storage Devices). CRUSH empowers Ceph clients to communicate with OSDs directly rather than through a centralized server or broker. With an algorithmically determined method of storing and retrieving data, Ceph avoids a single point of failure, a performance bottleneck, and a physical limit to its scalability.

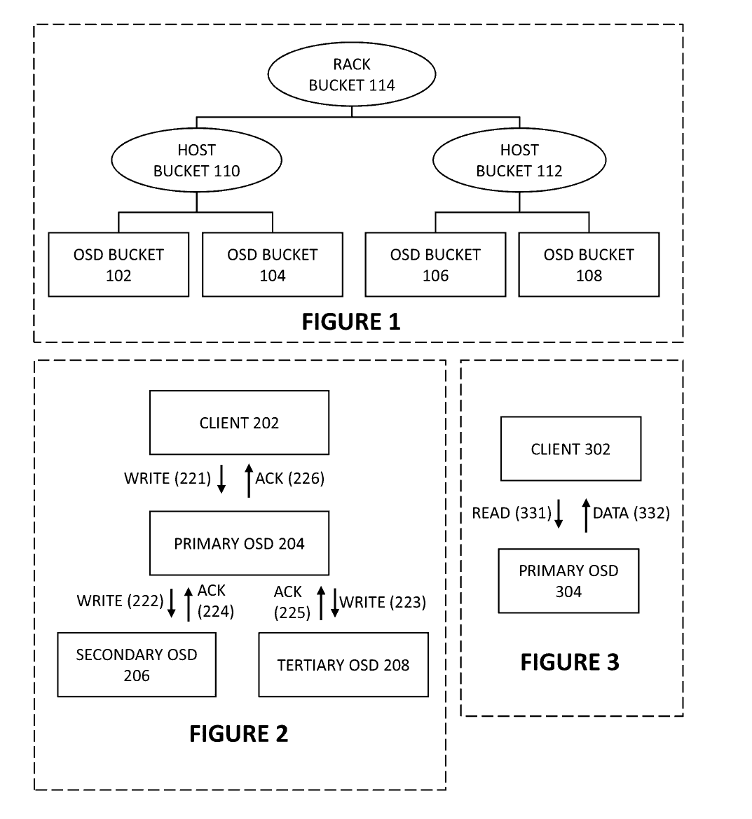

An important aspect of Ceph and CRUSH is the feature of maps, such as a hierarchical map for encoding information about the storage cluster (sometimes referred to as a CRUSH map in literature or publications). For instance, CRUSH uses the hierarchical map of the storage cluster to pseudo-randomly store and retrieve data in OSDs and achieve a probabilistically balanced distribution. FIG. 1 shows an exemplary hierarchical map of a storage cluster, according to some embodiments of the disclosure. The hierarchical map has leaf nodes and one or more parent node(s). The leaf nodes represent a corresponding storage device and each parent node aggregates one or more storage devices. A bucket can aggregates one or more storage devices (e.g., based on physical location, shared resources, relationship, etc.), and the bucket can be a leaf node or a parent node. In this example shown, the hierarchical map has four OSD buckets 102, 104, 106, AND 108. Host bucket 110 aggregates/groups OSD buckets 102 and 104; host bucket 112 aggregates/groups OSD buckets 106 and 108. Rack bucket 114 aggregates/groups host buckets 110 and 112 (and OSD buckets thereunder). Aggregation using buckets help users to easily understand/locate OSDs in a large storage cluster (e.g., to better understand/separate potential sources of correlated device failures), and rules/policies can be defined based on the hierarchical map. Many kinds of buckets exists, including, e.g., rows, racks chassis, hosts, locations, etc. Accordingly, CRUSH can determine how Ceph should replicate objects in the storage cluster based on the aggregation/bucket information encoded in the hierarchical map. As explained by the Ceph documentation, “leveraging aggregation CRUSH placement policies can separate object replicas across different failure domains while still maintaining the desired distribution.”

CRUSH is a procedure is used by Ceph OSD daemons to determine where replicas of objects should be stored (or rebalanced). As explained by the Ceph documentation, “in a typical write scenario, a client uses the CRUSH algorithm to compute where to store an object, maps the object to a pool [which are logical partitions for storing objects] and placement group [where a number of placement groups make up a pool], then looks at the CRUSH map to identify the primary OSD for the placement group.” Ceph provides a distributed Object Storage system that is widely used in cloud deployments as a storage backend. Currently, Ceph storage clusters have to be manually specified and configured in terms of what are all the OSDs referring to the individual storage devices, their location information, and their CRUSH Bucket topologies in the form of the hierarchical maps.

FIG. 2 shows an exemplary write operation, according to some embodiments of the disclosure. A client 202 writes an object to an identified placement group in a primary OSD 204 (task 221). Then, the primary OSD 204 identifies the secondary OSD 206 and tertiary OSD 208 for replication purposes, and replicates the object to the appropriate placement groups in the secondary OSD 206 and tertiary OSD 208 (as many OSDs as additional replicas) (tasks 222 and 223). The secondary OSD 206 can acknowledge/confirm the storing of the object (task 224); the tertiary OSD 208 can acknowledge/confirm the storing of the object (task 225). Once primary OSD 204 has received both acknowledgments and has stored the object on the primary OSD 204, the primary OSD 204 can respond to the client 202 with an acknowledgement confirming the object was stored successfully (task 226). Note that storage cluster clients and each Ceph OSD daemons can use the CRUSH algorithm and a local copy of the hierarchical map, to efficiently compute information about data location, instead of having to depend on a central lookup table.

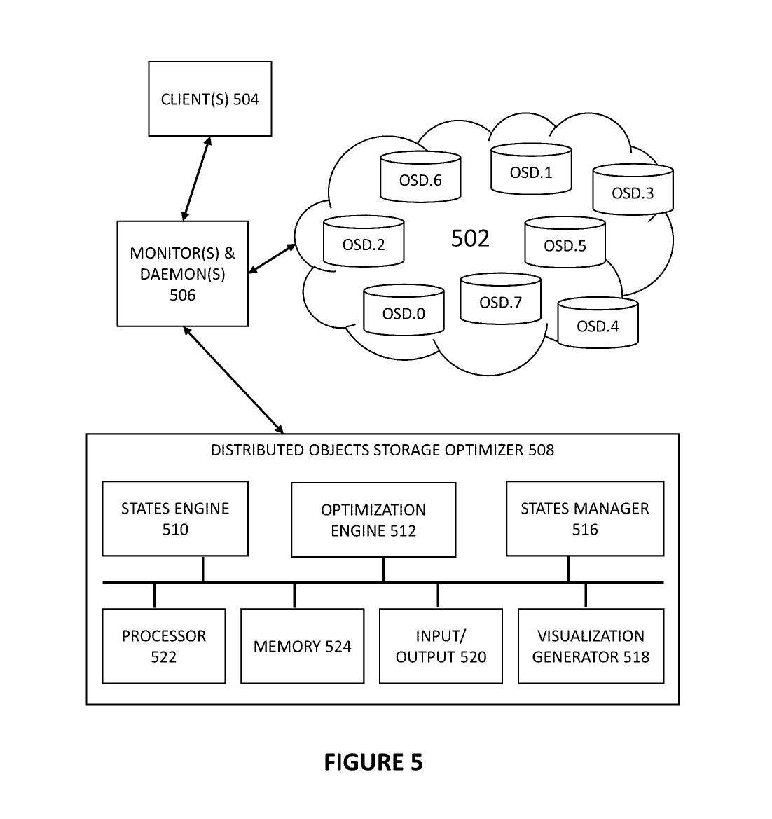

FIG. 3 shows an exemplary read operation, according to some embodiments of the disclosure. A client 302 can use CRUSH and the hierarchical map to determine the primary OSD 304 on which an object is stored. Accordingly, the client 302 requests a read from the primary OSD 304 (task 331) and the primary OSD 304 responds with the object (task 332). The overall Ceph architecture and its system components is described in further detail in relation to FIG. 5.

Limitations of Ceph and Existing Tools

A mechanism common to replication/writes operations and read operations is the use of CRUSH and the hierarchical map to determine OSDs for writing and reading of data. It is a complicated task for a system administrator to fill out the hierarchical map configuration file following the syntax of how to specify the individual devices, the various buckets created, their members and the entire hierarchical topology in terms of all the child buckets, their members, etc. Furthermore, a system administrator would have to specify several settings such as a bucket weights (a bucket weight per each bucket), which is an important parameter for CRUSH for deciding which OSD to use to store the object replicas. Specifically, bucket weights provide a way to, e.g., specify the relative capacities of the individual child items in a bucket. The bucket weight is typically encoded in the hierarchical map, i.e., as bucket weights of leafs and parent nodes. As an example, the weight can encode relative difference between storage capacities (e.g., a relative measure of number of bytes of storage an OSD has, e.g., 3 terabytes=>bucket weight=3.00, 1 terabyte=>bucket weight=1, 500 gigabytes=>bucket weight=0.5) to decide whether to select the OSD for storing the object replicas. The bucket weights are then used by CRUSH to distribute data uniformly among weighted OSDs to maintain a statistically balanced distribution of objects across the storage cluster. Conventionally, there is an inherent assumption in Ceph that the device load is on average proportional to the amount of data stored. But, it is not always true for a large cluster that has many storage devices with variety of capacity and performance characteristics. For instance, it is difficult to compare 250 GB SSD and 1 TB HDD. System administrators are encouraged to set the bucket weights manually, but no systematic methodology exists for setting the bucket weights. Worse yet, there are no tools to adjust the weights and reconfigure automatically based on the available set of storage devices, their topology, and their performance characteristics. When managing hundreds and thousands of OSDs, such a task for managing the bucket weights can become very cumbersome, time consuming, and impractical.

Systematic and Data-Driven Methodology for Managing and Optimizing Distributed Object Storage

To alleviate one or more problems of the present distributed object storage platform such as Ceph, an improvement is provided to the platform by offering a systematic and data-driven methodology. Specifically, the improvement advantageously addresses several technical questions or tasks. First, the methodology describes how to calculate/compute the bucket weights (for the hierarchical map) for one or more of these situations: (1) initial configuration of a hierarchical map and bucket weights based on known storage device characteristics, (2) reconfiguring weights for an existing (Ceph) storage cluster that has seen some OSD failures or poor performance, (3) when a new storage device is to be added to the existing (Ceph) cluster, and (4) when an existing storage device is removed from the (Ceph) storage cluster. Second, once the bucket weights are computed, the methodology is applied to optimization of write performance and read performance. Third, the methodology describes how to simplify and improve the user experience in the creation of these hierarchical maps and associated configurations.

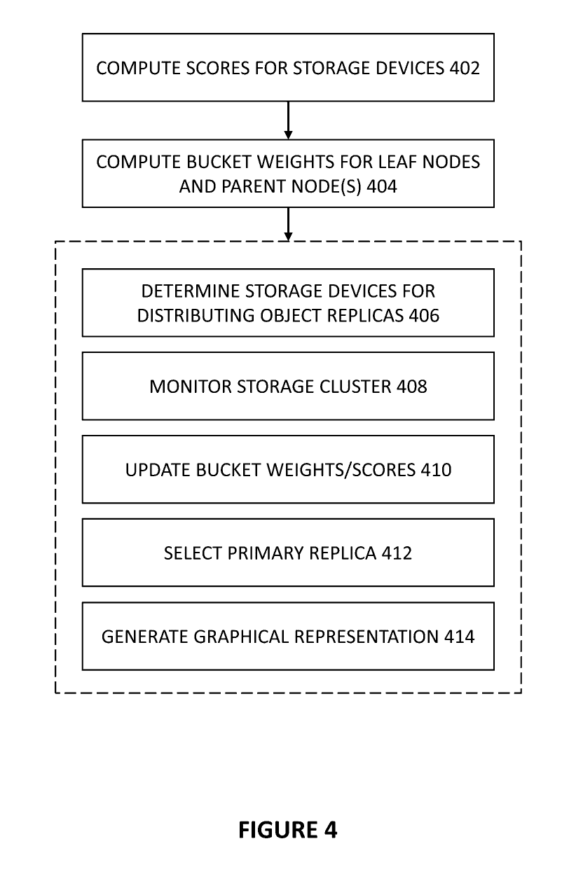

FIG. 4 is a flow diagram illustrating a method for managing and optimizing distributed object storage on a plurality of storage devices of a storage cluster, according to some embodiments of the disclosure. An additional component is added to the Ceph architecture, or an existing component of the Ceph architecture is modified/augmented for implementing such method. A states engine is provided to implement a systematic and data-driven scheme in computing and setting bucket weights for the hierarchical map. The method includes computing, by a states engine, respective scores associated with the storage devices (OSDs) based on a set of characteristics associated with each storage device and a set of weights corresponding to the set of characteristics (task 402).

The states engine can determine or retrieve a set of characteristics, such as vector C=<C1,C2,C3,C4, . . . > for each storage device. The characteristics, e.g., C1, C2, C3, C4, etc., in the vector are generally numerical values which enables a score to be computed based on the characteristics. Each numerical value preferably provides a (relatively) measurement of a characteristic of an OSD. The characteristics or the information/data on which the characteristic is based can be readily available as part of the platform, and/or can be maintained by a monitor which monitors the characteristics of the OSDs in the storage cluster. As an example, the set of characteristics of an OSD can include: capacity (e.g., size of the device, in gigabytes or terabytes), latency (e.g., current OSD latency, average latency, average OSD request latency, etc.), average load, peak load, age (e.g., in number of years), data transfer rate, type or quality of the device, performance rating, power consumption, object volume, number of read requests, number of write requests, and availability of data recovery feature(s).

Further to the set of characteristics, the states engine can determine and/or retrieve a set of weights corresponding to the set of characteristics. Based on the importance and relevance of each of these characteristics, a system administrator can decide a weight for each characteristic (or a weight can be set for each characteristic by default/presets). The weight allows the characteristics to affect or contribute to the score differently. In some embodiments, the set of weights are defined by a vector W=<W1,W2,W3,W4, . . . >. The sum of all weights may equal to 1, e.g., W1+W2+W3+W4+ . . . =1.

In some embodiments, computing the respective score comprises computing a weighted sum of characteristics based on the set of characteristics and the set of weights corresponding to the set of characteristics. For instance, the score can be computed using the following formula: S=C1*W1+C2*W2+C3*W3+ . . . In some embodiments, computing the respective score comprises computing a normalized score S′ as the respective score based on

$${S}^{′} = \frac{c + S - Min}{c + Max - Min} ,$$

wherein c is a constant (e.g., greater than 0), S is the respective score, Min is the minimum score of all respective scores, and Max is the maximum score of all respective scores. Phrased differently, the score is normalized over/for all the devices in the storage cluster to fall within a range of (0, 1] with values higher than 0, but less than or equal to 1.

Besides determining the scores for the storage devices, the method further includes computing, by states engine, respective bucket weights for leaf nodes and parent node(s) of a hierarchical map of the storage cluster based on the respective scores associated with the storage devices, wherein each leaf nodes represent a corresponding storage device and each parent node aggregates one or more storage devices (task 404). Computing the respective bucket weight for a particular leaf node representing a corresponding storage device can include assigning the respective score associated with the corresponding storage device as the respective bucket weight for the particular leaf node, and assigning a sum of respective bucket weight(s) for child node(s) of the parent node in the hierarchical map as the respective bucket weight of the particular parent node.

The process for computing the respective scores and respective bucket weights can be illustrated by the following pseudocode:

// for all the leaf nodes (representing OSDs), the bucket weights equal to
the normalized net scores S', for all the parent bucket nodes, it is a sum of
the weights of each of its children items.

ALGORITHM calculate_ceph_crush_weights(Node):
if Node is a leaf OSD node:

weight = normalized_net_score(Node) # as calculated above

else:
for each child_node of Node:

weight += calculate_ceph_crush_weights(child_node)

return weight

When used together, the set of characteristics and the set of weights make up an effective methodology for computing a score or metric for an OSD, and thus the bucket weights of the hierarchical map as well. As a result, the methodology can positively affect and improve the distribution of objects in the storage cluster (when compared to storage platforms where the bucket weight is defined based on the capacity of the disk only).

Once the bucket weight has been computed, the method can enable a variety of tasks to be performed with optimal results. For instance, the method can further include one or more of the following tasks which interacts with the hierarchical map having the improved bucket weights and scores: determine storage devices for distributing/storing object replicas for write operations (task 406), monitor storage cluster for a trigger which prompts the recalculation of the bucket weights (and scores) (task 408), updating of the bucket weights and scores (task 410), selecting a primary replica for read operations (task 412). Further to these tasks, a graphical representation of the hierarchical map can be generated (task 414) to improve the user experience.

### System Architecture

FIG. 5 is a system diagram illustrating an exemplary distributed storage platform and a storage cluster, according to some embodiments of the disclosure. The system can be provided to carry out the methodology described herein, e.g., the method illustrated in FIG. 4. The system can include a storage cluster 502 having a plurality of storage devices. In this example, the storage devices include OSD.0, OSD.1, OSD.2, OSD.3, OSD.4, OSD.5, OSD.6, OSD.7, OSD.8, etc. The system has monitor(s) and OSD daemon(s) 506 (there are usually several monitors and many OSD daemons). Recalling the principles of distributed object storage (e.g., Ceph), clients 504 can interact with OSD daemons directly (e.g., Ceph eliminates the centralized gateway), and CRUSH enables individual components to compute locations on which object replicas are stored. OSD daemons can create object replicas on OSDs to ensure data safety and high availability. The distributed object storage platform can use a cluster of monitors to ensure high availability (should a monitor fail). A monitor can maintain a master copy of the “cluster map” which includes the hierarchical map described herein having the bucket weights. Storage cluster clients 504 can retrieve a copy of the cluster map from the monitor. An OSD daemon can check its own state and the state of other OSDs and reports back to monitors. Clients 504 and OSD daemons can both use CRUSH to efficiently compute information about object location, instead of having to depend on a central lookup table.

The system further includes a distributed objects storage optimizer 508 which, e.g., can interact with a monitor to update or generate the master copy of the hierarchical map with improved bucket weights. The distributed objects storage optimizer 508 can include one or more of the following: a states engine 510, an optimization engine 512, a states manager 516, a visualization generator 518, inputs and outputs 520, processor 522, and memory 524. Specifically, the method (e.g., tasks 402 and 404) can be carried out by the states engine 510. The bucket weights can be used by the optimization engine 512, e.g., to optimize write operations and read operations (e.g., tasks 406 and 412). The states manager 516 can monitor the storage cluster (e.g., task 408), and the states engine 510 can be triggered to update bucket weights and/or scores (e.g., task 410). The visualization generator 518 can generate graphical representations (e.g., task 518) such as graphical user interfaces for render on a display (e.g., providing a user interface via inputs and outputs 520). The processor 522 (or one or more processors) can execute instructions stored in memory (e.g., one or more computer-readable non-transitory media) to carry out the tasks/operations described herein (e.g., carry out functionalities of the components/modules of the distributed objects storage optimizer 508).

Data-Driven Write Optimization

As discussed previously, bucket weights can affect amount of data (e.g., number of objects or placement groups) that an OSD gets. Using the improved bucket weights computed using the methodology described herein, an optimization engine (e.g., optimization engine 512 of FIG. 5) can determine, based on a pseudo-random data distribution procedure (e.g., CRUSH), a plurality of storage devices for distributing object replicas across the storage cluster using the respective bucket weights. For instance, the improved bucket weights can be used as part of CRUSH to determine the primary, secondary, and tertiary OSD for storing object replicas. Write traffic goes to all OSDS in the CRUSH result set. So, write throughput depends on the devices that are part of the result set. Writes will get slower if any of the acting OSDs is not performing as expected (because of hardware faults/lower hardware specifications). For that reason, using the improved bucket weights which carries information about the characteristics of the OSDs can improve and optimize write operations. Characteristics contributing to the improved bucket weight can include, e.g., disk throughput, OSD load, etc. The improved bucket weights can be used to provide better insights about the cluster usage and predict storage cluster performance. Better yet, updated hierarchical maps with the improved bucket weights can be injected into the cluster at (configured) intervals without compromising the overall system performance. CRUSH use the improved bucket weights to determine the primary, secondary, tertiary, etc. nodes for the replicas based on one or more CRUSH rules, and using the optimal bucket weights and varying them periodically can help in a better distribution. This functionality can provide smooth data re-balancing in the Ceph storage cluster without any spikes in the workload.

Data-Drive Read Optimization

In distributed storage platforms like Ceph, the primary replica is selected for the read traffic. There are different ways to specify the selection criteria of primary replica. By default, the primary replica is the first OSD in the CRUSH mapping result set (e.g., list of OSDs on which an object is stored). If the flag ‘CEPH_OSD_FLAG_BALANCE_READS’ is set, a random replica OSD is selected from the result set. 3) If the flag ‘CEPH_OSD_FLAG_LOCALIZE_READS’ is set, the replica OSD that is closest to the client is chosen for the read traffic. The distance is calculated based on the CRUSH location config option set by the client. This is matched against the CRUSH hierarchy to find the lowest valued CRUSH type. Besides these factors, a primary affinity feature allows the selection of OSD as the ‘primary’ to depend on the primary_affinity values of the OSDs participating in the result set. Primary_affinity value is particularly useful to adjust the read workload without moving the actual data between the participating OSDs. By default, the primary affinity value is 1. If it is less than 1, a different OSD is preferred in the CRUSH result set with appropriate probability. However, it is difficult to choose the primary affinity value without having the cluster performance insights. The challenge is to find the right value of ‘primary affinity’ so that the reads are balanced and optimized. To address this issue, the methodology for computing the improved bucket weights can be applied here to provide bucket weights (in place of the factors mentioned above) as the metric for selecting the primary OSD. Phrased differently, an optimization engine (e.g. optimization engine 512 of FIG. 5), can selecting a primary replica from a plurality of replicas of an object stored in the storage cluster based on the respective scores associated with storage units on which the plurality of replicas are stored. A suitable set of characteristics used for computing the score can include client location (e.g., distance between a client and an OSD), OSD load, OSD current/past statistics, and other performance metrics (e.g., memory, CPU and disk). The resulting selection for the primary OSD can be more intelligent, and thus performance of the read operations are improved. The scores computed using the methodology herein to be used as a metric can predict the performance of every participating OSD so as to decide the best among them to serve the read traffic. Read throughput thereby increases and cluster resources are better utilized.

Exemplary Characteristics

The set of characteristics can vary depending on the platform, the storage cluster, and/or preferences of the system administrator, examples include: capacity, latency, average load, peak load, age, data transfer rate, performance rating, power consumption, object volume, number of read requests, number of write requests, availability of data recovery feature(s), distance information, OSD current/past statistics, performance metrics (memory, CPU and disk), and disk throughput, etc. The set of characteristics can be selected by a system administrator, and the selection can vary depending on the storage cluster or desired deployment.

Flexible management: triggers which updates the scores and bucket weights

The systematic methodology not only provides an intelligent scheme for computing bucket weights, the scheme lends itself to a flexible system which can handle situations to optimally reconfigure the weight settings, when the device characteristics keep changing over time, or when new devices are added or removed from the cluster. A states manager (e.g., states manager 516 of FIG. 5) can monitor the storage cluster (e.g., task 408 of FIG. 4), and the states engine (e.g., states manager 510 of FIG. 5) can be triggered to update bucket weights and/or scores (e.g., task 410 OF FIG. 4). In order to reconfigure the bucket weights, the states engine can update the respective bucket weights by computing the respective scores again in response to one or more storage devices being added to the storage cluster and/or one or more storage devices being removed from the storage cluster. Specifically, the states engine can calculate the normalized scores S′ of each of the storage devices, and then run the calculate_ceph_crush_weights algorithm to reset the bucket weights of the hierarchical map. Triggers detectable by the states manager 516 can include monitoring when new storage device is added, or when an existing storage device is removed, or any other events which may prompt the reconfiguration of the bucket weights. The states manager 516 may also implement a timer which triggers the bucket weights to be updated periodically.

Graphical User Interface

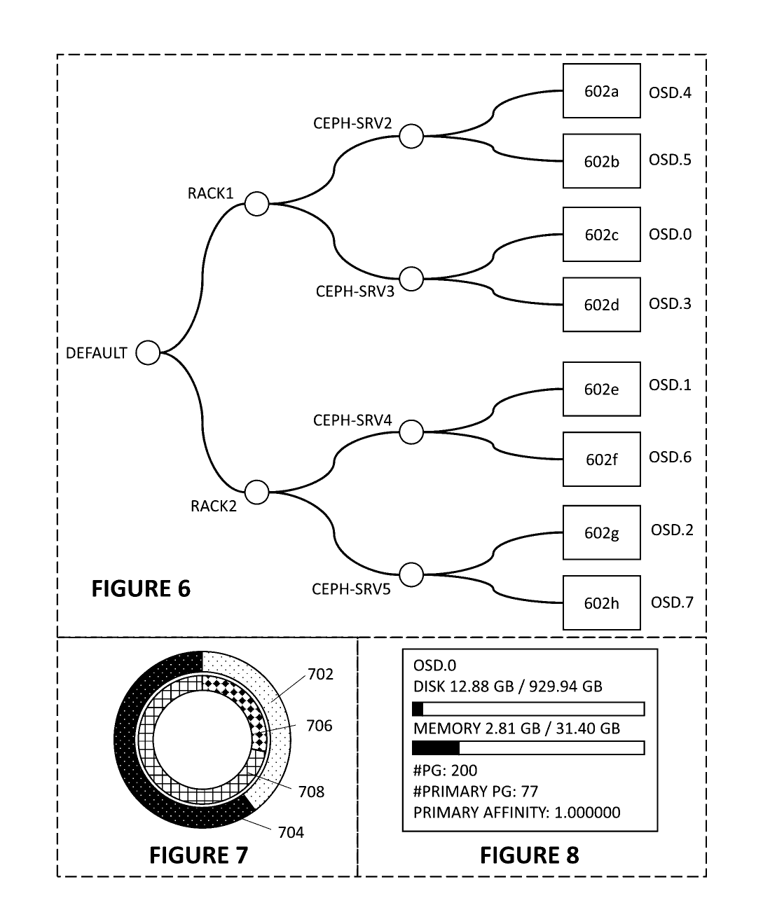

Conventional interface for managing a Ceph cluster is complicated and difficult to use. Rather than using a command line interface or a limited graphical user interface (e.g., Calamari), the following passages describes a graphical user interface which allows a user to interactively and graphically manage a Ceph cluster, e.g., view and create a hierarchical map using click-and-drag capabilities of adding items to the hierarchical map. FIG. 6 is an exemplary graphical representation of leaf nodes and parent nodes of a hierarchical map as a tree for display to a user, according to some embodiments of the disclosure. A visualization generator (e.g., visualization generator 518 of FIG. 5) can generate a graphical representation of leaf nodes and parent node(s) of the hierarchical map as a tree for display to a user (e.g., task 414 of FIG. 4). It can be seen from the example tree shown in FIG. 6 that a “default” bucket is a parent node of “rack1” bucket and “rack2” bucket. “Rack1” bucket has child nodes “ceph-srv2” bucket and “ceph-srv3”; “Rack2” bucket has child nodes “ceph-srv4” and “ceph-srv5”. “Ceph-srv2” bucket has leaf nodes “OSD.4” bucket representing OSD.4 and “OSD.5” bucket representing OSD.5. “Ceph-srv3” bucket has leaf nodes “OSD.0” bucket representing OSD.0 and “OSD.53” bucket representing OSD.3. “Ceph-srv4” bucket has leaf nodes “OSD.1” bucket representing OSD.1 and “OSD.6” bucket representing OSD.6. “Ceph-srv5” bucket has leaf nodes “OSD.2” bucket representing OSD.2 and “OSD.7” bucket representing OSD.7. Other hierarchical maps having different leaf nodes and parent nodes are envisioned by the disclosure, and will depend on the deployment and configurations. In the graphical representation, a particular leaf node of the tree (e.g., “OSD.0” bucket, “OSD.1” bucket, “OSD.2” bucket, “OSD.3” bucket, “OSD.4” bucket, “OSD.5” bucket, “OSD.6” bucket, “OSD.7” bucket) comprises a user interface element (e.g., denoted as 602a-h) graphically illustrating one or more of the characteristics in the set of characteristics associated with the corresponding storage device of being represented by the particular leaf node.

FIG. 7 is an exemplary user interface element graphically illustrating one or more characteristics associated with a storage device being represented by a leaf, according to some embodiments of the disclosure. Each of the individual OSD is represented by a user interface element (e.g., 602a-h of FIG. 6) as a layer of concentric circles. Each concentric circle can represent a heatmap of certain metrics, which can be customized to display metrics such as object volume and total number of requests, amount of read requests, and amount of write requests. Shown in the illustration are two exemplary concentric circles. Pieces 702 and 704 can form the outer circle; pieces 706 and 708 form the inner circle. The proportion of the pieces length of the arc) can vary depending on the metric like a guage. For instance, the arc length of piece 703 may be proportional to the amount of read requests an OSD has received in the past 5 minutes. When many of the user elements are displayed, a user can compare these metrics against OSDs. This graphical illustration gives a user insight on how the objects are distributed in the OSDs, and the amount of read/write traffic to the individual OSDs in the storage cluster, etc. User can drag a node and drop it into another bucket (for example, move SSD-host-1 to rack2), reflecting a real world change or logical change. The graphical representation can include a display of a list of new/idle devices, which a user can drag and drop to specific bucket. Moving/adding/deleting of the devices/buckets into the hierarchical map can result in the automatic updates of the bucket weights associated with the hierarchical map.

When user selects click on a node in the tree, a different user interface element can pops up some detail configurations about that node. FIG. 8 is another exemplary user interface element graphically illustrating one or more characteristics associated with a storage device being represented by a leaf, according to some embodiments of the disclosure. A user can any one or more of the configurations displayed at will. For instance, a user can edit the “PRIMARY AFFINITY” value for a particular OSD, or edit the number of placement groups that an OSD can store.

Further to the graphical representation of a hierarchical map as a tree, a visualization generator (e.g., visualization generator 518 of FIG. 5) can generate a user interface to allow a user to easily create and add CRUSH rules/policies. A user can use the user interface to add/delete/read/update the CRUSH rules without having to use a command line tool.

The user created hierarchical maps with the rules can be saved as a template, so that the user can re-use this at a later time. At the end of the creation of the hierarchical map using the user interfaces described herein, the user interface can provide an option to the user to load the hierarchical map and its rules to be deployed on the storage cluster.

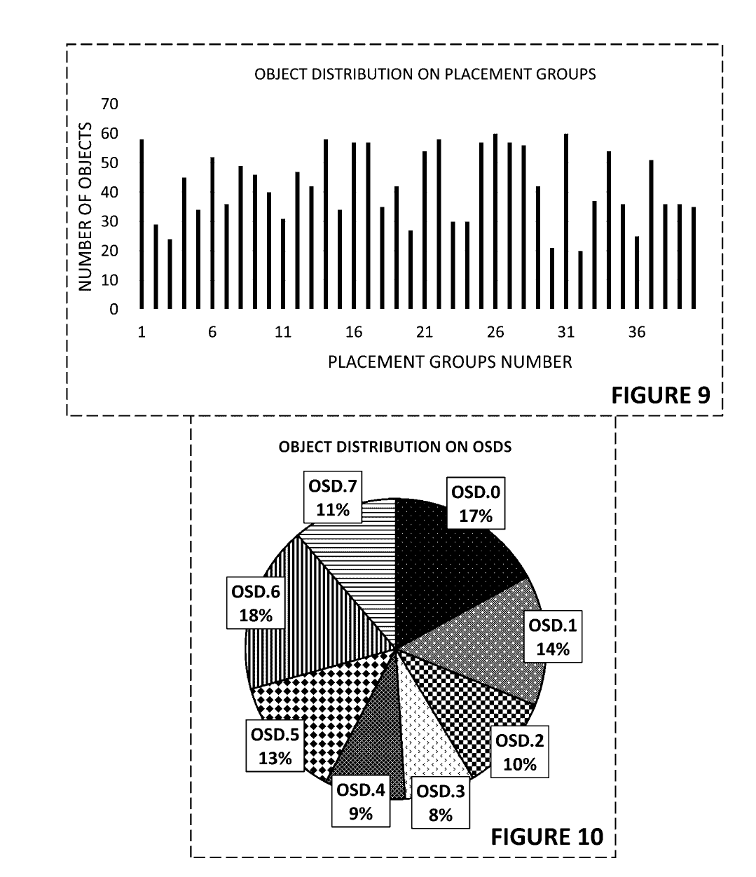

FIG. 9 is an exemplary graphical representation of object distribution on placement groups, according to some embodiments of the disclosure. The visualization generator (e.g., visualization generator 518 of FIG. 5) can generate a bar graph displaying the number of objects in each placement group. Preferably, the placement groups have roughly the same number of objects. The bar graph helps a user quickly learn whether the objects are evenly distributed over the placement groups. If not, a user may implement changes in configuration of the storage cluster rectify any issues.

FIG. 10 is an exemplary graphical representation of object distribution on OSDs, according to some embodiments of the disclosure. The visualization generator (e.g., visualization generator 518 of FIG. 5) can generate a pie chart to show how many objects an OSD has as a percentage of objects of all objects in the storage cluster. The pie chart can help a user quickly learn whether objects are evenly distributed over the OSDs. If not, a user may implement changes in configuration of the storage cluster rectify any issues.

Summary of Advantages

The described methodology and system provide a lot of advantages in terms of being able to automatically reconfigure the Ceph cluster settings to get the best performance. The methodology lends itself easily for accomodating reconfigurations that could be triggered by certain alarms or notifications, or certain policies, that can be configured based on the cluster's performance monitoring. With the data-driven methodology, the improved distributed object storage platform can implement systematic and automatic bucket weight configuration, better read throughput, better utilization of cluster resources, better cluster performance insights and prediction of the future system performance, faster write operations, less work spikes in case of device failures (e.g., automated rebalancing when bucket weights are updated in view of detected failures), etc.

The graphical representations generated by the visualization generator can provide an interactive graphical user interface that simplifies the creation of Ceph hierarchical maps (e.g., CRUSH maps) and bucket weights (e.g., CRUSH map configurations). A user no longer has to worry about knowing the syntax of the CRUSH map configurations, as the graphical user interface can generate the proper configurations in the backend in response to simple user inputs. The click and drag feature greatly simplifies the creation of the hierarchical map, and a visual way of representing the buckets makes it very easy for a user to understand the relationships and shared resources of the OSDs in the storage cluster.

Variations and Implementations

While the present disclosure describes Ceph as the exemplary platform, it is envisioned by the disclosure that the methodologies and systems described herein are also applicable to storage platforms similar to Ceph (e.g., proprietary platforms, other distributed object storage platforms). The methodology of computing the improved bucket weights enable many data-driven optimizations of the storage cluster. It is envisioned that the data-driven optimizations are not limited to the ones described herein, but can extend to other optimizations such as storage cluster design, performance simulations, catastrophe/fault simulations, migration simulations, etc.

Within the context of the disclosure, a network interconnects the parts seen in FIG. 5, and such network represents a series of points, nodes, or network elements of interconnected communication paths for receiving and transmitting packets of information that propagate through a communication system. A network offers communicative interface between sources and/or hosts, and may be any local area network (LAN), wireless local area network (WLAN), metropolitan area network (MAN), Intranet, Extranet, Internet, WAN, virtual private network (VPN), or any other appropriate architecture or system that facilitates communications in a network environment depending on the network topology. A network can comprise any number of hardware or software elements coupled to (and in communication with) each other through a communications medium.

As used herein in this Specification, the term ‘network element’ applies to parts seen in FIG. 5 (e.g., clients, monitors, daemons, distributed objects storage optimizer), and is meant to encompass elements such as servers (physical or virtually implemented on physical hardware), machines (physical or virtually implemented on physical hardware), end user devices, routers, switches, cable boxes, gateways, bridges, loadbalancers, firewalls, inline service nodes, proxies, processors, modules, or any other suitable device, component, element, proprietary appliance, or object operable to exchange, receive, and transmit information in a network environment. These network elements may include any suitable hardware, software, components, modules, interfaces, or objects that facilitate the bucket weight computations and data-driven optimization operations thereof. This may be inclusive of appropriate algorithms and communication protocols that allow for the effective exchange of data or information.

In one implementation, parts seen in FIG. 5 may include software to achieve (or to foster) the functions discussed herein for the bucket weight computations and data-driven optimization where the software is executed on one or more processors to carry out the functions. This could include the implementation of instances of states engine, optimization engine, states manager, visualization generator and/or any other suitable element that would foster the activities discussed herein. Additionally, each of these elements can have an internal structure (e.g., a processor, a memory element, etc.) to facilitate some of the operations described herein. In other embodiments, these functions for bucket weight computations and data-driven optimizations may be executed externally to these elements, or included in some other network element to achieve the intended functionality. Alternatively, parts seen in

FIG. 5 may include software (or reciprocating software) that can coordinate with other network elements in order to achieve the bucket weight computations and data-driven optimization functions described herein. In still other embodiments, one or several devices may include any suitable algorithms, hardware, software, components, modules, interfaces, or objects that facilitate the operations thereof.

In certain example implementations, the bucket weight computations and data-driven optimization functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by one or more processors, or other similar machine, etc.). In some of these instances, one or more memory elements can store data used for the operations described herein. This includes the memory element being able to store instructions (e.g., software, code, etc.) that are executed to carry out the activities described in this Specification. The memory element is further configured to store data structures such as hierarchical maps (having scores and bucket weights) described herein. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the bucket weight computations and data-driven optimizations, as outlined herein. Additionally, each of these devices may include a processor that can execute software or an algorithm to perform the bucket weight computations and data-driven optimizations as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that the systems described herein are readily scalable and, further, can accommodate a large number of components, as well as more complicated/sophisticated arrangements and configurations. Accordingly, the examples provided should not limit the scope or inhibit the broad techniques of bucket weight computations and data-driven optimizations, as potentially applied to a myriad of other architectures.

It is also important to note that the steps in the FIG. 4 illustrate only some of the possible scenarios that may be executed by, or within, the parts seen in FIG. 5. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by parts seen in FIG. 5 in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for managing and optimizing distributed object storage on a plurality of storage devices of a storage cluster, the method comprising:
computing, by a states engine, respective scores associated with the storage devices based on a set of characteristics associated with each storage device and a set of weights corresponding to the set of characteristics; and
computing, by the states engine, respective bucket weights for leaf nodes and parent node(s) of a hierarchical map of the storage cluster based on the respective scores associated with the storage devices, wherein each leaf nodes represent a corresponding storage device and each parent node aggregates one or more storage devices.

2. The method of claim 1, further comprising:
determining, by an optimization engine, based on a pseudo-random data distribution procedure, a plurality of storage devices for distributing object replicas across the storage cluster using the respective bucket weights.

3. The method of claim 1, further comprising:
selecting, by an optimization engine, a primary replica from a plurality of replicas of an object stored in the storage cluster based on the respective scores associated with storage units on which the plurality of replicas are stored.

4. The method of claim 1, wherein the set of characteristics comprises one or more: capacity, latency, average load, peak load, age, data transfer rate, performance rating, power consumption, object volume, number of read requests, number of write requests, and availability of data recovery feature(s).

5. The method of claim 1, wherein computing the respective score comprises computing a weighted sum of characteristics based on the set of characteristics and the set of weights corresponding to the set of characteristics.

6. The method of claim 1, wherein computing the respective score comprises computing a normalized score as the respective score based on
$$\frac{c + S - Min}{c + Max - Min} ,$$
wherein c is a constant, S is the respective score, Min is the minimum score of all respective scores, and Max is the maximum score of all respective scores.

7. The method of claim 1, wherein computing the respective bucket weight for a particular leaf node representing a corresponding storage device comprises assigning the respective score associated with the corresponding storage device as the respective bucket weight for the particular leaf node.

8. The method of claim 1, wherein computing the respective bucket weight for a particular parent node aggregating one or more storage devices comprises assigning a sum of respective bucket weight(s) for child node(s) of the parent node in the hierarchical map as the respective bucket weight of the particular parent node.

9. The method of claim 1, further comprising:
updating, by the states manager, the respective bucket weights by computing the respective scores again in response to one or more storage devices being added to the storage cluster and/or one or more storage devices being removed from the storage cluster.

10. The method of claim 1, further comprising:
generating, by a visualization generator, a graphical representation of leaf nodes and parent node(s) of the hierarchical map as a tree for display to a user, wherein a particular leaf node of the tree comprises a user interface element graphically illustrating one or more of the characteristics in the set of characteristics associated with the corresponding storage device of being represented by the particular leaf node.

11. A distributed objects storage optimizer for managing and optimizing distributed object storage on a plurality of storage devices of a storage cluster, comprising:
at least one memory element;
at least one processor coupled to the at least one memory element; and
a states engine that when executed by the at least one processor is configured to:
compute respective scores associated with the storage devices based on a set of characteristics associated with each storage device and a set of weights corresponding to the set of characteristics; and
compute respective bucket weights for leaf nodes and parent node(s) of a hierarchical map of the storage cluster based on the respective scores associated with the storage devices, wherein each leaf nodes represent a corresponding storage device and each parent node aggregates one or more storage devices.

12. The distributed objects storage optimizer of claim 11, further comprising:
an optimization engine that when executed by the at least one processor is configured to determine based on a pseudo-random data distribution procedure, a plurality of storage devices for distributing object replicas across the storage cluster using the respective bucket weights.

13. The distributed objects storage optimizer of claim 11, further comprising:
an optimization engine that when executed by the at least one processor is configured to select a primary replica from a plurality of replicas of an object stored in the storage cluster based on the respective scores associated with storage units on which the plurality of replicas are stored.

14. The distributed objects storage optimizer of claim 11, wherein the set of characteristics comprises one or more: capacity, latency, average load, peak load, age, data transfer rate, performance rating, power consumption, object volume, number of read requests, number of write requests, and availability of data recovery feature(s).

15. The distributed objects storage optimizer of claim 11, wherein computing the respective score comprises computing a weighted sum of characteristics based on the set of characteristics and the set of weights corresponding to the set of characteristics.

16. A computer-readable non-transitory medium comprising one or more instructions, for managing and optimizing distributed object storage on a plurality of storage devices of a storage cluster, that when executed on a processor configure the processor to perform one or more operations comprising:
computing, by a states engine, respective scores associated with the storage devices based on a set of characteristics associated with each storage device and a set of weights corresponding to the set of characteristics; and
computing, by the states engine, respective bucket weights for leaf nodes and parent node(s) of a hierarchical map of the storage cluster based on the respective scores associated with the storage devices, wherein each leaf nodes represent a corresponding storage device and each parent node aggregates one or more storage devices.

17. The medium of claim 16, wherein computing the respective score comprises computing a normalized score as the respective score based on
$$\frac{c + S - Min}{c + Max - Min} ,$$
wherein c is a constant, S is the respective score, Min is the minimum score of all respective scores, and Max is the maximum score of all respective scores.

18. The medium of claim 16, wherein computing the respective bucket weight for a particular leaf node representing a corresponding storage device comprises assigning the respective score associated with the corresponding storage device as the respective bucket weight for the particular leaf node.

19. The medium of claim 16, wherein computing the respective bucket weight for a particular parent node aggregating one or more storage devices comprises assigning a sum of respective bucket weight(s) for child node(s) of the parent node in the hierarchical map as the respective bucket weight of the particular parent node.

20. The medium of claim 16, wherein the operations further comprises:
updating the respective bucket weights by computing the respective scores again in response to one or more storage devices being added to the storage cluster and/or one or more storage devices being removed from the storage cluster.
